(19) United States
(12) Patent Application Publication
(10) Pub. No.: US 2007/0190213 A1
(43) Pub. Date: Aug. 16, 2007

(54) Processes for encapsulating protein and products thereof

(76) Inventors: Jerome W. Harden, Philadelphia, PA (US); Charles I. Onwulata, Cheltenham, PA (US)

Correspondence Address: USDA, ARS, OTT, 5601 SUNNYSIDE AVE, RM 4-1159, BELTSVILLE, MD, 20705-5131, US

(21) Appl. No.: 11/226,084

(22) Filed: Sep. 14, 2005

Related U.S. Application Data
(60) Provisional application No. 60/610,462, filed on Sep. 16, 2004.

(51) Int. Cl. A23L 1/00

(52) U.S. Cl. 426/302

(57) ABSTRACT

Methods of encapsulating fully denatured or partially denatured protein (e.g., whey) involving milling the protein into a fine powder, pouring the powdered protein into a bowl containing an encapsulating agent (e.g., lipid), heating the combination until the encapsulating agent melts, and mixing the combination until the protein is completely covered/encapsulated. After the protein is covered/encapsulated, it is cooled so that it can be added as an ingredient to other foods.

### CROSS-REFERENCE TO RELATED APPLICATIONS

The present application claims the benefit under all relevant U.S. statutes, including 35 U.S.C. 120, to U.S. Application. No. 60/610,462 titled “PROCESSES FOR ENCAPSULATING WHEY PROTEIN AND PRODUCTS THEREOF”, to Jerome W. Harden and Charles I. Onwulata, and U.S. application. Ser. No. 10/767,979, titled FOOD PRODUCTS CONTAINING PARTIALLY AND/OR TOTALLY DENATURED MILK PROTEINS, to Charles I. Onwulata, which in turn claims the benefit of priority under 35 U.S.C. 120 to U.S. patent application Ser. No. 10/686,834, titled FOOD PRODUCTS CONTAINING TEXTURIZED MILK PROTEINS, to Charles I. Onwulata. All of these applications are incorporated by reference as if fully set forth herein.

### FIELD OF THE INVENTION

The present invention relates generally to encapsulation and, more specifically, to processes for making encapsulated protein (e.g., fully or partially denatured proteins such as whey protein) for use in processed foods.

### BACKGROUND OF THE INVENTION

The people living in most developed nations are experiencing a severe health crisis. The sedentary life-styles and the poor eating habits of these people contribute to the high rates of obesity and diabetes found in these countries. Accordingly, quick and easy methods of losing weight are widely popular.

Currently, several of the most popular methods of losing weight stress a diet high in protein but low in carbohydrates. Unfortunately, the people living in the developed nations have an “addiction” for snack foods. The typical snack food (e.g., potato chips, pretzels, tortilla chips, etc.) is low in protein, high in carbohydrates, and high in fats, resulting in a high number of “empty” calories. Accordingly, it would be desirable to produce a snack food that provides a relatively high amount of protein and a significantly lower number of carbohydrates.

It has been the goal of snack-food manufacturers to develop such a snack food. Unfortunately, it is difficult to introduce protein into the snack-food manufacturing process because a relatively high heat is required in the snack-food manufacturing process. The introduction of protein into a snack-food recipe results in a poor quality (e.g., taste and texture) snack food because the protein interferes with the matrix forming tough-to-expand pastes. Thus there is a need to develop new methods to produce high protein snack foods.

### SUMMARY OF THE INVENTION

The present invention concerns processes for encapsulating fully denatured or partially denatured protein (e.g., whey) by way of extrusion and using such processes to produce food products (specifically, snack-food products). Of particular interest is the use of encapsulated whey protein so that it may be incorporated into, for example, stone ground corn masa or a dough or batter made from any grain (e.g., corn, wheat, rice, barley, rye, potato, or mixtures thereof) to create a food product that has a relatively high nutritional value, such as breads, biscuits, muffins, tortilla chips, and other food products.

The fully denatured or partially denatured protein (e.g., whey) is preferably encapsulated in an encapsulating agent (e.g., lipid) using a heated process. After the lipid has melted (for example, in a planetary mixing bowl), and after the fully denatured or partially denatured protein is prepared by milling it into a fine powder, the milled protein is then added to the mixing bowl and coated. The coated protein is then cooled for later use as a nutritional supplement in foods (e.g., snacks) that have high moisture content preparations.

In the present invention, a protein is encapsulated in an encapsulating agent (e.g., high-melt lipid such as a lipid).

### BRIEF DESCRIPTION OF THE DRAWINGS

The accompanying drawings, which are incorporated in and form a part of the specification, illustrate the embodiments of the present invention and, together with the following description, serve to explain the principles of the invention. For the purpose of illustrating the invention, there are shown in the drawings embodiments which are presently preferred, it being understood, however, that the invention is not limited to the specific instrumentality or the precise arrangement of elements or process steps disclosed.

FIG. 1 is a chart illustrating the various steps for converting milk into whey protein.

FIG. 2 is a block diagram showing the process for encapsulating protein (e.g., filly or partially denatured) within a lipid.

FIG. 3 is a block diagram showing a process for manufacturing a food (e.g., snack) using the encapsulated whey protein in accordance with the present invention.

FIG. 4 is a series of pictures of what the protein looks like before and after encapsulation; figure (4a) shows the surface of the protein, which has very sharp edges and is very porous adding to its hygroscopic nature; FIGS. 4b and 4c clearly show a smooth surface void of any pores.

### DETAILED DESCRIPTION OF THE PREFERRED EMBODIMENT

Unless defined otherwise, all technical and scientific terms used in this description have the same meaning as commonly understood by one of ordinary skill in the art to which this invention belongs.

In describing a preferred embodiment of the invention, specific terminology will be selected for the sake of clarity. However, the invention is not intended to be limited to the specific terms so selected, and it is to be understood that each specific term includes all technical equivalents that operate in a similar manner to accomplish a similar purpose.

Preferred embodiments of the present invention will now be described in detail, with reference to the accompanying drawings.

Whey protein is a highly desirable protein to be used in the manufacturing of food products. Whey proteins are high quality and nutritious. Some of the reasons whey protein is so desirable is that it is one of the most complete proteins (i.e., it provides all of the essential amino acids that the body needs and which a healthy body cannot synthesize on its own), it is readily available for the body to use (i.e., it provides an almost immediate source of energy), and it is highly digestible. Accordingly, it is a good choice of ingredient to use in the manufacture of foods (e.g., snacks).

Whey proteins can differ dramatically from one another depending on the processing method. Whey protein can exist as simple whey powder (30% or less total protein content), whey protein concentrate (30-85% protein) or whey protein isolate (90% or higher protein content). Whey protein isolate is the purest form of whey protein; it contains little or no fat or lactose. The United States Department of Agriculture has specified that dry whey protein concentrate shall contain not less than 25% or more than 89.9% protein.

U.S. Pat. No. 6,610,347, issued Aug. 26, 2003, to Charles I. Onwulata, discloses a dietary fiber composition produced by a process involving cooking calcium caseinate slurry, or a calcium caseinate and whey protein isolate slurry, in an evaporator to produce a slurry of cross-linked matrices of protein, adding dietary fiber to the slurry, and spray atomizing the dietary fiber/slurry mixture in a spray dryer. U.S. Pat. No. 6,610,347 is hereby incorporated by reference as if fully set forth herein.

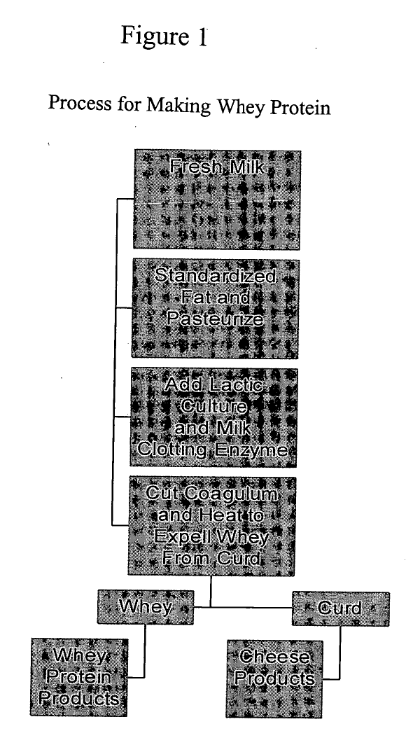

Referring to FIG. 1, the usual steps needed to produce (dairy) whey protein is illustrated. Milk contains two primary proteins, namely whey protein and casein. Raw milk is first homogenized. Cheese, a concentrated dairy food made from milk, is defined as the fresh or matured product obtained by draining the whey (moisture or serum of original milk) after coagulation of casein, the major milk protein. Casein is coagulated by acid, which is produced through the addition of select microorganisms and/or by coagulating enzymes, resulting in curd formation. Milk may also be acidified by adding food-grade acidulants, which is the process often used in the manufacture of fresh cheese. Next, the whey is separated out, usually by coagulation with a microbial rennet enzyme.

The present invention utilizes partially or completely denatured proteins which are produced by a process wherein the proteins in a protein containing product are partially or completely denatured. This process involves processing the protein containing product through an extruder (e.g., single screw extruder, preferably twin screw extruder) at low shear (generally about 50-about 450 rpm (e.g., 50-450 rpm), preferably about 50-about 300 rpm (e.g., 50-300 rpm), more preferably about 50-about 200 rpm (e.g., 50-200 rpm), most preferably about 50-above 100 rpm (e.g., 50-100 rpm)), at a temperature in the extruder of about 40′ to about 120° C. (e.g., 40° to 120° C.). Pressures may range from about 10 to about 2000 psi (e.g., 10-2000 psi), preferably about 500 to about 1500 psi (e.g., 500-1500 psi), more preferably about 800 to about 1200 psi (e.g., 800-1200psi)), and torque may range from about 30 to about 70% (e.g., 30-70% , preferably about 45 to about 55% (e.g., 45-55%). Residence time of the protein containing product in the extruder is generally about 15-about 90 seconds (e.g., 15-90 seconds), preferably about 20-about 75 seconds (e.g., 20-75 seconds), and more preferably about 35-about 60 seconds (e.g., 35-60 seconds). To produce completely denatured proteins, the temperature generally is about 90° to about 120° C. (e.g., 90° to 120° C.), more preferably about 95° to about 120° C. (e.g., 95° to 120° C.), most preferably about 100° to about 110° (e.g., 100° to 110° C.); the shear is preferably about 50 to about 100 rpm (e.g., 50-100 rpm). Completely denatured proteins are generally ≧95% (e.g., 95%) denatured, preferably ≧99% (e.g., 99%) denatured, more preferably about 100% (e.g., 100%) denatured. To produce partially denatured proteins, the temperature generally is about 40° to about 90° C. (e.g., 40° to 90° C.), more preferably about 55° to about 80° C. (e.g., 55° to 80° C.), most preferably about 60° to about 70° C. (e.g., 60° to 70° C.); the shear is preferably about 150 to about 250 rpm (e.g., 150-250 rpm). Partially denatured proteins are generally <95% denatured, preferably <about 90% (e.g., <90%) denatured, more preferably about 40-about 80% (e.g., 40-80%) denatured. Low shear increases the residence time of the protein containing product in the extruder since residence time is a fuiction of the rpm of the extruder, the residence time can increase from 45 to 90 seconds. The protein containing product may be any protein containing product fit for human consumption; examples include milk protein containing products such as milk, milk concentrate, milk protein concentrate, whey, whey protein concentrate, whey protein isolate. The process may also utilize other protein containing products such as, for example, vegetable protein (e.g., legumes, soy protein), animal protein (e.g., chicken protein, beef protein, fish protein), and egg protein.

The present invention concerns in part encapsulated fully denatured or partially denatured protein and products thereof.

The following discloses a process for making an encapsulated fully denatured or partially denatured protein and products thereof. Of particular interest is use of encapsulated whey protein so that it may be incorporated into, for example, stone ground corn masa or a masa made from corn meal or cooked whole corn to create a snack food product that is relatively high in nutritional value. Other uses would include foodstuffs that would have high moisture content where the encapsulated protein could be used to create a nutritional food product. Without being bound by theory, by encapsulating the protein, it is protected from moisture during the mixing process and prevents the protein from binding with the water used in the mix.

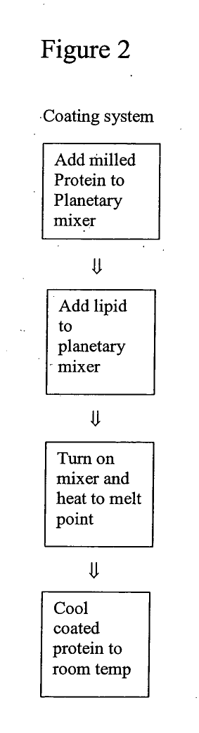

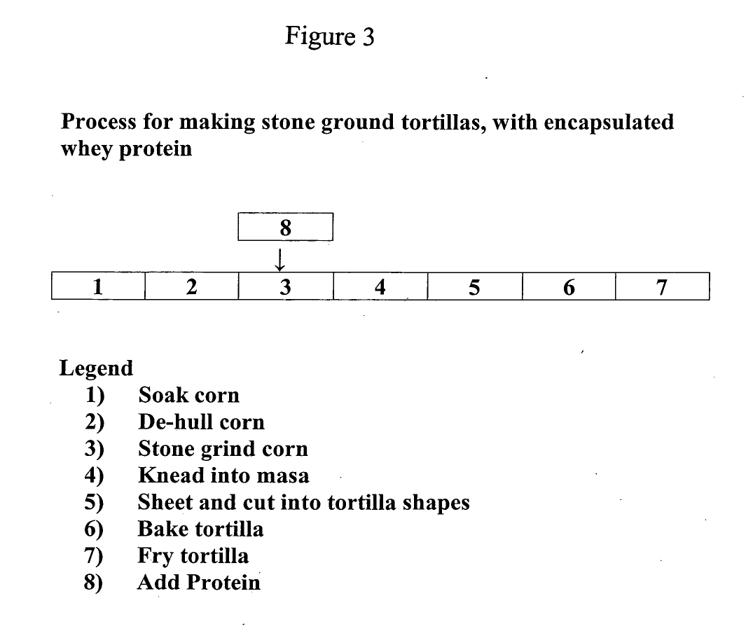

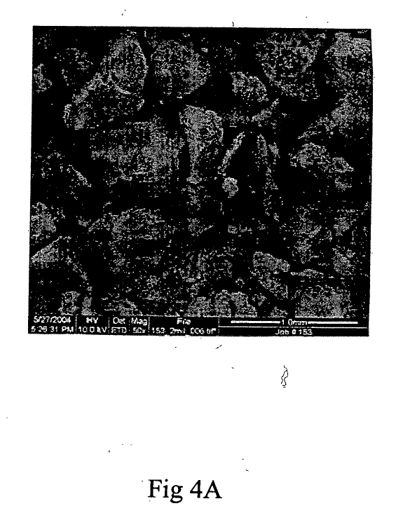

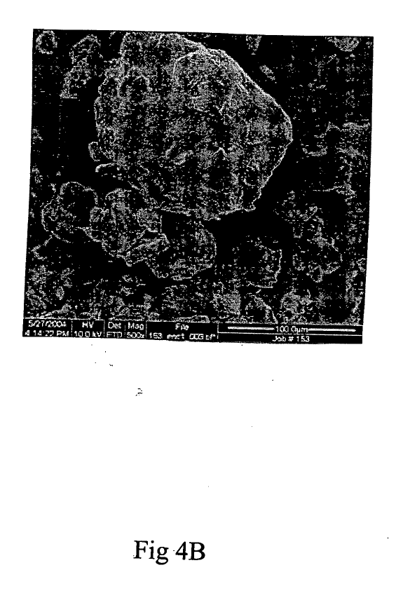

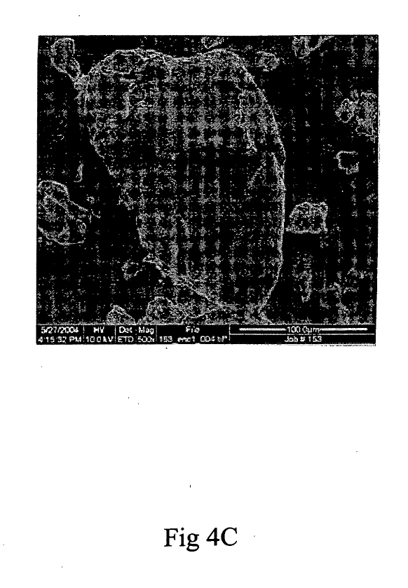

Referring now to FIG. 2, the first step in the subject process for making lipid encapsulated protein involves milling (e.g., about 30 seconds using a Fitzpatrick DA-6 SS 12 blade hammer mill) fully denatured or partially denatured protein; next the milled protein is combined with an encapsulating agent forming a product mixture (e.g., about 80%-about 95% protein and about 5%-about 20% lipid). The milled protein is combined with the encapsulating agent and heated and mixed (e.g., about 30 minutes); the temperature of the product mixture is raised until the encapsulating agent melts and the product mixture is mixed until the protein is completely covered by the encapsulating agent, thereby encapsulating the protein. The required temperature to melt the encapsulating agent depends on the encapsulating agent and generally ranges from about 125°-about 185° F. (preferably from about 125°-about 150° F.). Finally, the encapsulated protein is cooled under continued mixing (e.g., about 30 minutes) until it forms a powder (e.g., substantially free-flowing powder). The encapsulating agent generally may be any lipid fit for human consumption; for example, myristic acid, lauric acid, palmitic acid, stearic acid, arachidic acid, oleic acid, linoleic acid, linolenic acid, arachidonic acid, beeswax, camuba wax, Vitamin A, Vitamin D, Vitamin E, Vitamin K, or lipids (e.g., oils) obtained from coconut, corn (e.g., corn oil), olive (e.g., olive oil), palm, peanut (e.g., peanut oil), or safflower. Other encapsulating agents besides lipids can be used to achieve this effect: a wide range of cellulose derivatives, ethyl cellulose, methyl cellulose, sodium hydoxymethyl cellulose, zein, shellac, agar, alginates, dextrins, starches, and gelatins; generally these encapsulating agents would be dispersed and dissolved in an aqueous liquid and a milled protein would be fluidized in an airborne stream in a fluid-bed coating system and a spray of the film forming encapsulating liquid would be sprayed down onto the protein particles and coating them with the film forming liquid.

The fully denatured or partially denatured protein is preferably encapsulated in a lipid using a planetary mixing bowl. This allows the protein to be stirred and evenly coated while the encapsulating agent is substantially simultaneously melted. Other encapsulating methods known in the art could be used to accomplish this, such as Fluidized Bed. When the encapsulated protein is cooled, it resembles a fine powder. The encapsulated protein can be stored for later use as a nutritional supplement in foods (e.g., snacks) that have high moisture content preparations.

When the encapsulated protein is cooled down to room temperature it forms a dry, solid product. The solid product can then easily be packaged, distributed, and/or added to a food (e.g., snack) mixture. The dry solid product has the physical characteristics of a free flowing powder, comprising particles ranging in size from approximately 25 nm (nanometers) to about 200 nm in diameter. The dry solid product has a faint characteristic odor, somewhat similar to that of dried milk powder, when whey protein is used. The encapsulated fully denatured or partially denatured protein, produced by the process of the preferred embodiment, generally delivers macronutrients to the body by the addition to food (e.g., snack) products, leading to a significant supply of nutrients for the human body relative to the nutritionless foods (e.g., snacks) currently available.

The present invention also concerns a protein enriched food product containing partially or completely denatured proteins or combinations thereof described above which are encapsulated (as described herein) and at least one food ingredient. The food ingredient may be any food ingredient. For example, the food ingredient may be the ingredients for cookies or muffins such as flour. Furthermore, the food ingredient may be shelf-stable packaged pre-mixes for preparing food and beverage compositions, usually requiring the addition of other ingredients (e.g., eggs, shortening, water or milk) to be supplied and added by the preparer. Additionally, the food ingredient may be a ready-to-cook mix (combined food ingredients that require additional cooking (e.g., baking frying, micro waving) to form a ready-to-eat food or beverage product). Generally, the food product (e.g., protein enriched) may be any food product such as a drink, yogurt, or pizza, or a bakery product such as cake, biscuit, pie crust, cookie, muffin, bread, cereal, doughnut, noodle, brownie, cracker or snack food. The amount of the encapsulated partially or completely denatured proteins contained in the enriched food product may be any amount that does not adversely affect the food product (for example, the food product may contain about 1% to about 40% of the encapsulated partially or completely denatured proteins, preferably about 5% to about 30%, more preferably about 5% to about 20% , most preferably about 10% to about 15%).

Partially denatured proteins may be used to create a totally expanded or puffed snack food product (or pellets or half products), which may be fully cooked or ready-to-eat, that also contains at least one food ingredient (e.g., any starch source such as corn, wheat, rice, barley, rye, potato, or mixtures thereof). Currently, unmodified milk protein containing products (e.g., whey) when added to expanded products collapse the matrix and do not puff, and thus it is necessary to limit substituting whey for starch to about 5%. Surprisingly, the partially denatured proteins can replace well over 5% (e.g., about 5%-about 35%) of the starch without affecting puff characteristics while allowing one to obtain desirable crunch and crispness notwithstanding the high level of milk protein containing products contained therein. Generally, the composition containing partially denatured proteins can replace >about 0% to about 60% of the starch (e.g., >0-60%), preferably >about 5% to about 60% (e.g., >5-60%), more preferably about 10%-about 50% (e.g., 10-50%), most preferably about 20%-about 40% (e.g., 20-40%). The totally expanded or puffed snack food product may contain about 5%-about 80% (e.g., 5-80%) of the partially denatured proteins, preferably about 15%-about 60% (e.g., 15-60%), more preferably about 20%-about 40% (e.g., 20-40%). The expanded or puffed food product (or pellets or half products) may be made by methods known in the art. For example, the partially denatured proteins of the present invention were blended with corn meal at the ratio of 25 g of the partially denatured proteins and 75 g corn meal. The blend of the partially denatured proteins and corn meal were extruded in a ZSK30 twin screw extruder (Krupp, Werner & Pfleiderer Company, Ramsey, N.J.) consisting of nine heating-barrel sections each individually controlled; the first six zones were present at 35°, 35°, 50°, 50°, 75°, and 90° C. respectively, and the last 3 barrel temperatures were set at 100°, 110°, and 125° C., respectively. The die plate was fitted with two circular inserts (3.18 mm diameter). Melt temperatures was recorded at the die. The blend was fed into the extruder with a series 6300 digital type 35 twin screw volumetric feed (K-Tron Corp., Pitman, N.J.) at a constant setting of 800 rpm yielding a feed rate of 128.5 g/min. Water was added at a rate of 1.3 L/h with an electromagnetic dosing pump (Milton Roy, Acton, Mass.) to bring the moisture content of the feed to approximately 18 g H₂O/100 g product (wet basis). The screw speed of the extruder was maintained at 300 rpm. The screw elements were selected to provide high shear at 300 rpm by adding kneading blocks to the configuration. The process may also utilize other proteins such as, for example, soy protein, vegetable protein, animal protein, and other carbohydrate sources such as wheat, barely, rice, and starch.

In addition to the encapsulation process described above, the present invention concerns food products—and, in particular, snack food products-that can incorporate the encapsulated protein. In a preferred embodiment, the encapsulated protein is used in the process for manufacturing tortilla chips. The typical prior art process for making tortilla chips includes steeping husks of corn; removing the hull from the steeped corn; milling the hulled corn; adding water to the milled corn to form a masa; rolling the masa between two rollers to produce a sheet of masa of a predetermined thickness; cutting the sheeted masa into a desired shape (usually triangular); baking the triangular-shaped masa in an oven; frying the baked masa; and finally flavoring the fried chips with the desired seasonings.

Although some snack foods are amenable to the introduction of whey protein during the cooking process, many snack foods (including tortilla chips and cheese curls) cannot be made with the simple introduction of whey protein. The reason is that the dried protein has an affinity for water. If dried whey protein was introduced directly into the masa, it would draw out most of the water in the masa thereby ruining the masa and preventing the proper formation of sheeting that gets cut into triangular shapes that form the tortilla chips. Also, proteins are altered by the cooking process. When proteins are heated, they tend to make the foods they are in tough and chewy, creating a meat-like mouthfeel thereby destroying the taste and texture of the food. By introducing a predetermined quantity (e.g., about 5%-about 35%, preferably about 10%-about 25%, more preferably about 15%-about 20%) of encapsulated whey protein of the present invention into the masa, two problems are surprisingly solved. First, the protein is separated from the wet masa thereby preventing the wicking of moisture from the masa. Second, the protein is protected from the heating process preventing the conversion of the protein into long chains; therefore, food products made by the subject process retain their original taste and texture (in particular, they do not become tough and “chewy”).

Other baked goods that have a high moisture content are candidates for replacing a portion of the dough/batter with encapsulated whey protein. A person skilled in the art, after reading this disclosure, will be able to adopt the methods and processes herein to manufacture lower carbohydrate muffins, cakes and pies.

Yet another object of the present invention is to produce a whey protein, encased in a lipid, for decreasing body fat in association with appropriate exercise and dietary changes.

Still another object of the present invention is to produce a whey protein, encased in a lipid, which results in improved exercise performance.

Yet another object of the present invention is to produce an encapsulated whey protein to be combined with carbohydrates, for the treatment of catabolic conditions in patients at clinical and/or hospital situations.

Still another object of the present invention is to produce a lipid encapsulated protein from any one or a combination of proteins, the group consisting of, whey protein isolates, whey protein concentrate, whey peptides, whey dipeptides, whey oligopeptides, whey polypeptides, soy protein (including dipeptides, polypeptides and oligopeptides), casein protein, and egg albumin protein.

A food product is a dietary fiber composition when it contains completely denatured proteins since completely denatured proteins are indigestible.

The following examples are intended only to further illustrate the invention and are not intended to limit the scope of the invention as defined by the claims.

### EXAMPLES

Partially denatured protein: Whey Protein Isolate (PROVON 190) was purchased from Glanbia Ingredients; moisture 2.8%, protein 89.6%, fat 25, ash 3.3%, carbohydrate by difference. A ZSK-30 twin screw extruder (Krupp Werner Pfleiderer Co., Ramsey, N.J.) with a smooth barrel was used. The extruder had nine zones, and the effective cooking zones 6, 7, 8, and 9 were set to the same temperature 75° C. The cooking zones were set to the same barrel temperature of 75° C. Zones 1 to 3 were set to 35° C. and zones 4 and 5 were set to 75° C. Melt temperature was monitored behind the die. The die plate was fitted with two circular inserts of 3.18 mm diameter each. The screw elements were selected to provide low shear at 300 rpm; the screw profile was described by Onwulata et al. (Onwulata, C. I., et al., J. Food Sci., 63(5): 814-818). Feed was conveyed into the extruder with a series 6300 digital feeder, type T-35 twin screw volumetric feeder (K-tron Corp., Pitman, NJ). The feed screw speed was set at 600 rpm, corresponding to a rate of 3.50 kg/h. Water was added into the extruder at the rate of 1.0 L/h with an electromagnetic dosing pump (Milton Roy, Acton, Mass.). Samples were collected after 25 min of processing, freeze-dried overnight in a VirTis Freeze Mobile 12XL Research Scale Freeze Dryer (Gardiner, N.Y.), and stored at 4.4° C.

Partially denatured protein prepared above was milled for 30 seconds using a Fitzpatrick DA-6 SS 12 blade hammer mill. The milled protein (20 to 60 microns particle size) was combined with a powdered encapsulating lipid (cotton seed or corn oil) with a melt point of 135° F. at a ratio of 60% protein to 40% lipid in a mixing vessel (Jacketed Littleford Day Plow mixer). The mixer was then turned on and at 35 rpm was used to create a homogenous mixture of lipid and protein. Hot water was then pumped through the jacket of the mixer to heat up the lipid/protein combination to a temperature of 175° F. with continuous mixing for 30 minutes, the encapsulating agent melted and the product mixture was mixed until the protein was completely covered by the encapsulating agent, thereby encapsulating the protein. The encapsulated protein was cooled by running chilled water through the jacket on the mixer under continued mixing for 30 minutes until it formed a substantially free-flowing powder. The encapsulated protein was then used to make tortilla chips. Husks of corn were steeped, the hull was removed from the steeped corn, the hulled corn was milled and water was added to the milled corn to form a masa in a hobart style mixer. The encapsulated protein was added to the masa at 25% by weight and mixed for 10 minutes, the masa/encapsulated protein mixture was then passed between two rollers to produce a sheet of masa about ⅛th inch thick, the sheeted masa was cut into triangular shapes and baked in an oven at 475° F. for 35 seconds, and the baked masa was fried in hot corn oil 475° F. for 15 seconds. The result was a protein enriched crispy tortilla chip.

All of the references cited herein are incorporated by reference in their entirety. Also incorporated by reference in their entirety are the following U.S. Pat. Nos. 4,232,047; 5,603,952; 6,610,347. Also incorporated by reference in their entirety are the following U.S. applications: Ser. No. 10/767,979; 10/686,834; 60/610,462.

Thus, in view of the above, the present invention concerns (in part) the following:

A process for making encapsulated protein, comprising (or consisting essentially of or consisting of) milling fully denatured or partially denatured protein to form milled protein, mixing said milled protein with an encapsulating agent to form a mixture of milled protein and encapsulating agent, heating and mixing said mixture of milled protein and encapsulating agent to a temperature wherein said encapsulating agent melts to form melted encapsulating agent and said milled protein is encapsulated with said melted encapsulating agent to form encapsulated protein.

The above process, further comprising cooling and mixing said encapsulated protein to form an encapsulated protein powder.

The above process, wherein said encapsulating agent is chosen from the group consisting of myristic acid, lauric acid, palmitic acid, stearic acid, arachidic acid, oleic acid, linoleic acid, linolenic acid, arachidonic acid, beeswax, carnuba wax, Vitamin A, Vitamin D, Vitamin E, Vitamin K, lipids obtained from coconut, corn, olive, palm, peanut, safflower, and mixtures thereof.

The above process, wherein said encapsulating agent is chosen from the group consisting of lipids obtained from corn, olive, peanut, and mixtures thereof.

The above process, wherein said encapsulating agent is selected from the group consisting of ethyl cellulose, methyl cellulose, sodium hydoxymethyl cellulose, zein, shellac, agar, alginate, dextrin, starch, gelatin, and mixtures thereof.

The above process, wherein said encapsulating agent has a melting point of about 125°—about 185° F.

The above process, wherein said encapsulating agent has a melting point of about 125° —about 150° F.

The above process, wherein said protein is chosen from the group consisting of whey protein isolate, whey protein concentrate, whey peptides, whey dipeptides, whey oligopeptides, whey polypeptides, whey oligopeptides, soy protein, soy dipeptides, soy polypeptides, soy oligopeptides, casein protein, egg albumin protein, and mixtures thereof.

The above process, wherein said protein is chosen from the group consisting of milk, milk concentrate, milk protein concentrate, whey, whey protein concentrate, whey protein isolate, and mixtures thereof.

The above process, wherein said protein is chosen from the group consisting of whey protein concentrate, whey protein isolate, and mixtures thereof.

The above process, wherein said heating and mixing takes place in a planetary mixing bowl.

Encapsulated protein produced by the above process.

A process for manufacturing tortilla chips, said process comprising (or consisting essentially of or consisting of) steeping corn to form steeped corn, removing the hull from said steeped corn to form hulled corn, milling said hulled corn to form milled corn, adding water to said milled corn to form a masa, introducing encapsulated protein into said masa, sheeting said masa to form sheeted masa, cutting said sheeted masa to form cut masa, baking said cut masa in an oven to form baked tortilla chip, and frying said baked tortilla chips.

The above process, further comprising seasoning said fried masa with spices and flavorings.

Tortilla chips produced by the above process.

A method of replacing a portion of flour or dough in a food product, said method comprising (or consisting essentially of or consisting of) substituting an encapsulated protein for a portion of said flour or dough.

The above method, said method comprising substituting an encapsulated whey protein for >5-about 35% of said flour or dough.

The above method, wherein said food product is a puffed or expanded food product.

A food product prepared by the above method.

The above food product, wherein said food product is a puffed or expanded food product.

The above food product, wherein said food product further comprises a food ingredient selected from the group consisting of corn, potato, wheat, barley, rice, rye, and mixtures thereof.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

We claim:

1. A process for making encapsulated protein, comprising milling fully denatured or partially denatured protein to form milled protein, mixing said milled protein with an encapsulating agent to form a mixture of milled protein and encapsulating agent, heating and mixing said mixture of milled protein and encapsulating agent to a temperature wherein said encapsulating agent melts to form melted encapsulating agent and said milled protein is encapsulated with said melted encapsulating agent to form encapsulated protein.

2. The process according to claim 1, further comprising cooling and mixing said encapsulated protein to form an encapsulated protein powder.

3. The process according to claim 1, wherein said encapsulating agent is chosen from the group consisting of myristic acid, lauric acid, palmitic acid, stearic acid, arachidic acid, oleic acid, linoleic acid, linolenic acid, arachidonic acid, beeswax, carnuba wax, Vitamin A, Vitamin D, Vitamin E, Vitamin K, lipids obtained from coconut, corn, olive, palm, peanut, safflower, and mixtures thereof.

4. The process according to claim 1, wherein said encapsulating agent is chosen from the group consisting of lipids obtained from corn, olive, peanut, and mixtures thereof.

5. The process according to claim 1, wherein said encapsulating agent is selected from the group consisting of ethyl cellulose, methyl cellulose, sodium hydoxymethyl cellulose, zein, shellac, agar, alginate, dextrin, starch, gelatin, and mixtures thereof.

6. The process according to claim 1, wherein said encapsulating agent has a melting point of about 125°-about 185° F.

7. The process according to claim 1, wherein said encapsulating agent has a melting point of about 125°-about 150° F.

8. The process according to claim 1, wherein said protein is chosen from the group consisting of whey protein isolate, whey protein concentrate, whey peptides, whey dipeptides, whey oligopeptides, whey polypeptides, whey oligopeptides, soy protein, soy dipeptides, soy polypeptides, soy oligopeptides, casein protein, egg albumin protein, and mixtures thereof.

9. The process according to claim 1, wherein said protein is chosen from the group consisting of milk, milk concentrate, milk protein concentrate, whey, whey protein concentrate, whey protein isolate, and mixtures thereof.

10. The process according to claim 1, wherein said protein is chosen from the group consisting of whey protein concentrate, whey protein isolate, and mixtures thereof.

11. The process according to claim 1, wherein said heating and mixing takes place in a planetary mixing bowl.

12. Encapsulated protein produced by the process according to claim 1.

13. A process for manufacturing tortilla chips, said process comprising steeping corn to form steeped corn, removing the hull from said steeped corn to form hulled corn, milling said hulled corn to form milled corn, adding water to said milled corn to form a masa, introducing encapsulated protein into said masa, sheeting said masa to form sheeted masa, cutting said sheeted masa to form cut masa, baking said cut masa in an oven to form baked tortilla chip, and frying said baked tortilla chips.

14. The process according to claim 13 further comprising seasoning said fried masa with spices and flavorings.

15. Tortilla chips produced by the process according to claim 13.

16. A method of replacing a portion of flour or dough in a food product, said method comprising substituting an encapsulated protein for a portion of said flour or dough.

17. The method according to claim 16, said method comprising substituting an encapsulated whey protein for >5-about 35% of said flour or dough.

18. The method according to claim 16, wherein said food product is a puffed or expanded food product.

19. A food product prepared by the method according to claim 16.

20. The food product according to claim 19, wherein said food product is a puffed or expanded food product.

21. The food product according to claim 19, wherein said food product further comprises a food ingredient selected from the group consisting of corn, potato, wheat, barley, rice, rye, and mixtures thereof.
